(19) United States
(12) Patent Application Publication
(10) Pub. No.: US 2025/0341617 A1
(43) Pub. Date: Nov. 6, 2025

(54) DEVICE FOR MEASURING THE DISTANCE OF AN OBJECT, PROCESS FOR PRODUCING AN OPTICAL FIBER FOR USE IN SUCH A DEVICE AND METHOD FOR MEASURING THE DISTANCE OF AN OBJECT

(71) Applicant: Dimetix AG, Herisau (CH)

(72) Inventors: Kurt GIGER, Rüthi (CH); Andreas ZÜND, Speicher (CH); Stefan TAESCHLER, Gossau (CH)

(73) Assignee: Dimetix AG, Herisau (CH)

(21) Appl. No.: 18/948,734

(22) Filed: Nov. 15, 2024

(30) Foreign Application Priority Data
Nov. 15, 2023 (EP) 23210024.8

(51) Int. Cl. G01S 7/481; G01S 17/26; G02B 3/04

(52) U.S. Cl. CPC G01S 7/4818; G01S 7/4813; G01S 7/4814; G01S 7/4816; G01S 17/26; G02B 3/04

(57) ABSTRACT

A device (1) for measuring a distance of an object at which laser radiation modulated and emitted by the device (1) are reflected is disclosed. The device comprises an optical fiber (2) into which laser radiation can be coupled and a main lens (3) through which the laser radiation can be emitted along an optical axis (4) of the main lens. The optical fiber (2) comprises a decoupling surface (5), wherein a reflective layer (6), in particular an annular surface, is arranged on the decoupling surface (5).

The invention is directed to a device for measuring a distance of an object, a process for producing an optical fiber for use in such a device, and a method for measuring a distance of an object.

Optical distance meters based on laser measurement are known from the prior art. Such distance meters use the time-of-flight (TOF) principle or phase modulation as measuring techniques. Particularly when used in an industrial environment, such measuring devices are exposed to temperature variations, vibrations and other challenges that can influence the measuring accuracy. In addition, an optical light output surface and an optical light input surface are usually provided, which are not in the same place, so that the measuring devices do not work at very short distances. Another challenge is that very small deviations in the measuring device lead to large measurement errors at long distances.

It is therefore the object of the invention to create a device for measuring the distance of an object, a process for producing an optical fiber for use in such a device and a process for measuring the distance of an object which avoids the disadvantages of the prior art. In particular, a device for measuring a distance with an associated process is to be created which can measure accurately under challenging conditions.

The object is solved by a device for measuring a distance, a process for producing an optical fiber for use in such a device and a process for measuring a distance according to the independent claims.

In particular, the object is solved by a device for measuring a distance of an object on which laser radiation modulated and emitted by the device is reflected. The device comprises an optical fiber into which laser radiation can be coupled and a main lens through which the laser radiation can be emitted along an optical axis. The optical fiber comprises a decoupling surface, whereby a reflective layer, in particular an annular reflective layer, is arranged on the decoupling surface.

A device of this type enables the laser radiation used for measurement to be emitted and received again on the same surface of the optical fiber, so that measurements can also be taken at short distances. Calibration is optimized as the reference channel and measurement channel are almost identical. The transmit and receive channels are focused simultaneously, so that no adjustment from transmit axis to receive axis is necessary. The adjustment is also temperature-stable, as the temperature influences are the same for the transmit and receive channels. The reflective layer can be a gold coating, for example.

With a ring-shaped reflective layer, the laser radiation can be emitted through the center of the optical fiber and, after being reflected by the object to be measured, can be reflected back through the lens onto the reflective layer.

The decoupling surface can be arranged at a non-perpendicular angle to the optical axis of the optical fiber. The angle can be in the range of 25° to 65° to the optical axis of the main lens, in particular in the range of 35° to 55°, in particular essentially 52°. Preferably, the sum of the angles of the optical axis of the optical fiber to the optical axis of the main lens and the angle of the decoupling surface to the optical axis of the optical fiber is essentially 45°.

This means that the reflected laser light can be guided from the reflective layer of the decoupling surface to a receiver which does not have to be arranged in the range of the main lens of the device, but at a different location within the device depending on the angle of the decoupling surface.

This makes the device easier and more compact to manufacture.

Laser radiation can be conducted from the reflective layer to a receiver, whereby the receiver is in particular an avalanche photodiode and is preferably arranged at a distance of 0.01 mm to 2 mm, preferably 0.05 mm to 0.3 mm or 0.4 mm to 1 mm, in particular 0.3 mm to 0.6 mm, from the reflective layer.

Such a close arrangement of the receiver to the reflective layer ensures that sufficient reflected laser light is received and can be processed by the electronics.

The receiver can comprise a hemispherical lens or a spherical lens.

The optical fiber can be a single mode optical fiber and, in particular, a polarization-maintaining fiber.

The use of a single mode fiber results in low signal attenuation, hardly any delay shifts and the possibility of using high bandwidths. Furthermore, a single mode fiber has a smaller diameter of the light outlet. The single mode fiber can be used to generate optimally small laser dots on the target surface. With the polarization-maintaining fiber, the outcoupling reflex can be minimized or deliberately controlled.

A coupling device for laser coupling can be formed on a coupling surface of the optical fiber. This allows the laser light to be optimally coupled into the optical fiber.

A coupling device can comprise spherical lenses and/or cylindrical lenses. The coupling device can also be a conical optical fiber.

The device can comprise a laser source, in particular a laser diode, whose light can be coupled into the optical fiber and by which light with a wavelength in a range of essentially 490 nm to 950 nm can preferably be generated. In particular, light with 490-575 nm and/or 630-680 nm and/or 780-950 nm can be generated.

With a laser source of this type, the laser light required for measurement can be optimally generated and transmitted through the fiber optics.

Alternatively, a fiber laser can be used instead of the laser diode. A fiber laser is particularly suitable for short pulses <100 ps and high-precision measurements, as there are no wavelength jumps within the pulse. The fiber laser can then replace the optical fiber and comprise the decoupling surface according to the invention. Optionally, an optical fiber to which a reflector has been attached can be spliced to the fiber laser, analogous to the optical fiber decoupling surface as described above.

The main lens can be at least partially covered with dispersion spatter on the side facing the optical fiber so that diffuse light can be reflected. In particular, dispersion spatter can be printed on with an inkjet printer. UV-curable ink, in particular white ink, can be used as the ink for the dispersion spatter. This means that the dispersion spatters can be applied reproducibly and are easy to cure.

This means that a diffuse calibration signal can be obtained from the lens. In particular, 1% to 20% of the lens surface is covered with diffusion spatter.

Alternatively, a diffusely reflecting foil or a partial mirror coating can be arranged in the transmission area, i.e. the side of the main lens facing the optical fiber

By using a diffuse calibration signal, which is compared with the measurement signal, which is also diffuse. This increases the accuracy.

The calibration signal is necessary to eliminate the delay times of the measurement electronics and also the changes in the delay and thus to achieve an accurate measurement result, especially in an accuracy range of 0.1 mm. For this purpose, the measurement and calibration signals should be as identical as possible.

The main lens can be a spherical lens, in particular an achromatic doublet lens. The transmitter is focused by a spherical lens and the received signal is defocused by the doublet lens outside of the sensor range.

The double lens can also be used to eliminate chromatic and spherical aberrations. This also helps to optimize accuracy.

The main lens can be an aspherical lens, in particular an aspherical plastic lens.

Different focal lengths can be formed in an asphere so that the lens has different focal lengths in the center and in the ring outside the center. This can also be achieved using a hybrid lens. Alternatively, a film with a hole in the center or thin glass can be glued on. Thin glass can also be placed in front of the lens. The aspherical lens can also have different radii in the transmitting radiation area and in the receiving radiation area. A plastic lens is inexpensive to manufacture, but is defocused in the temperature range. A combination of spherical glass lens and aspherical plastic lens is also conceivable. This combines the accuracy of the glass lens with the favorable manufacturing costs of the plastic lens. In addition, active focusing in the temperature range is possible with a plastic lens.

The optical axis of the main lens can be arranged neither coaxially nor parallel to the optical axis of the optical fiber, but can have an angle in the range of 1° to 359°, in particular 1° to 179°, preferably +/−10° to 30° to each other.

This means that the optical fiber, in particular the optical axis of the optical fiber, is arranged at an angle to the optical axis of the main lens so that, in combination with the non-perpendicular angle of the decoupling surface, the positioning of the receiver of the measuring light can be optimized.

Both the receiver and the main lens have a mount, each of which has a greater coefficient of thermal expansion than the holder connecting the mount.

The mount can be made of aluminum or aluminum alloy, for example, or magnesium or zinc alloys. The holder that connects the mounts can be a carbon fiber tube, for example, or nickel-steel alloys, titanium or chrome steel. The decisive factor here is the difference in the coefficient of thermal expansion between the materials.

The device also comprises a signal processing device and signal processing electronics. In particular, the signal processing electronics comprise a single-channel receiver chain with calibration and measurement signals serially time-shifted. The signal processing electronics must have a high bandwidth, especially for short measurement distances.

The signal processing device enables the detection of multiple reflections.

The object is further solved by a process for producing an optical fiber using a device as described above, in which in particular a decoupling surface of the optical fiber is ground at a non-perpendicular angle to the optical axis of the optical fiber, the decoupling surface is coated with a reflecting layer, the reflecting layer is removed from the decoupling surface in a transmission range around the center of the optical fiber by penetration of UV light into the optical fiber, so that only the middle range of the reflecting layer is removed again.

In this way, a decoupling surface of the optical fiber can be coated with an annular reflecting layer while the center remains permeable to the transmitted radiation. Preferably, the UV laser is temporarily coupled into the optical fiber by splicing so that the applied reflecting layer can be removed with the UV laser. The removed layer has a diameter of essentially approx. 5 μm. As an alternative to splicing in, a fiber connector can also be provided, via which the UV laser and the red measuring laser can be exchanged.

A process for measuring the distance of an object at which modulated and emitted laser radiation is reflected by a device as described above, whereby a laser source generates modulated laser light as transmitted radiation, the transmitted radiation is coupled into the optical fiber, the transmitted radiation is coupled out of the optical fiber through the transmission area in the decoupling surface, and a small part of the transmitted radiation is coupled out of the optical fiber, in particular a small part of the transmitted radiation is reflected by the inside of the main lens, the transmitted radiation passes through the main lens, the transmitted radiation is reflected by an object, the reflected laser light passes through the main lens as received radiation, the received radiation is reflected by the reflecting layer of the decoupling surface and is directed to a receiver.

This process enables accurate distance measurement that is largely independent of environmental factors.

The invention is explained in more detail below with the aid of figures. It shows:

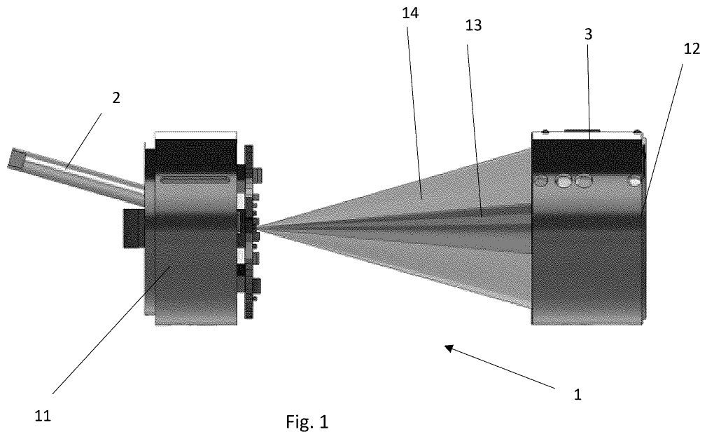

FIG. 1: A schematic representation of the optics of the device,

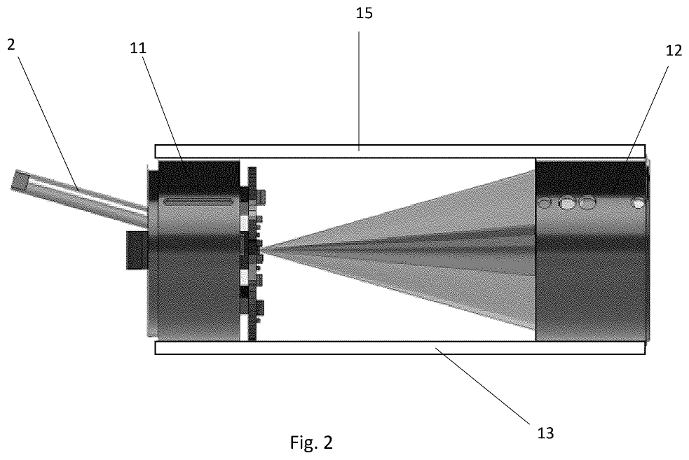

FIG. 2: a schematic representation of the optics of the device with holder,

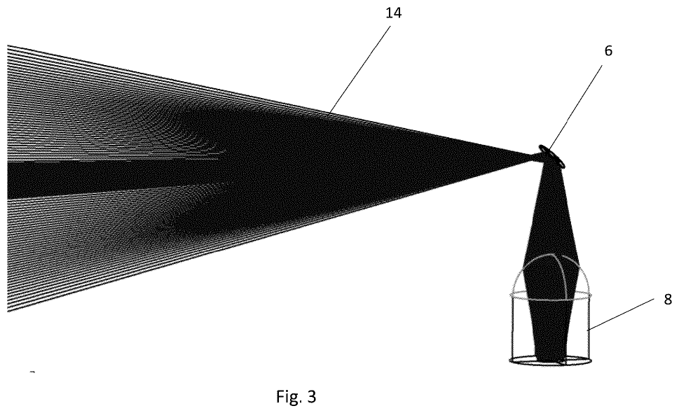

FIG. 3: a schematic representation of the reflective layer and the path of the receiving radiation,

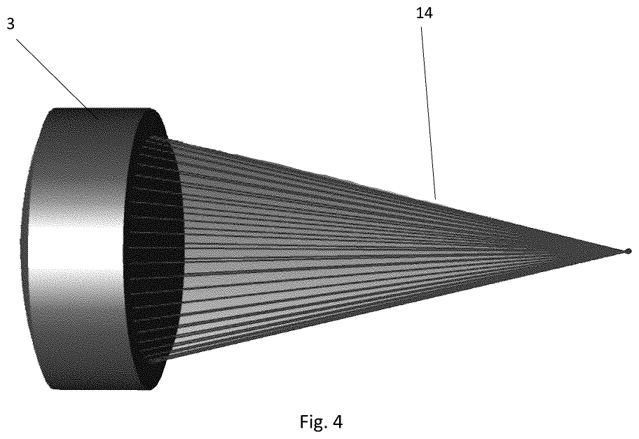

FIG. 4: a schematic representation of the main lens with the path of the receiving radiation,

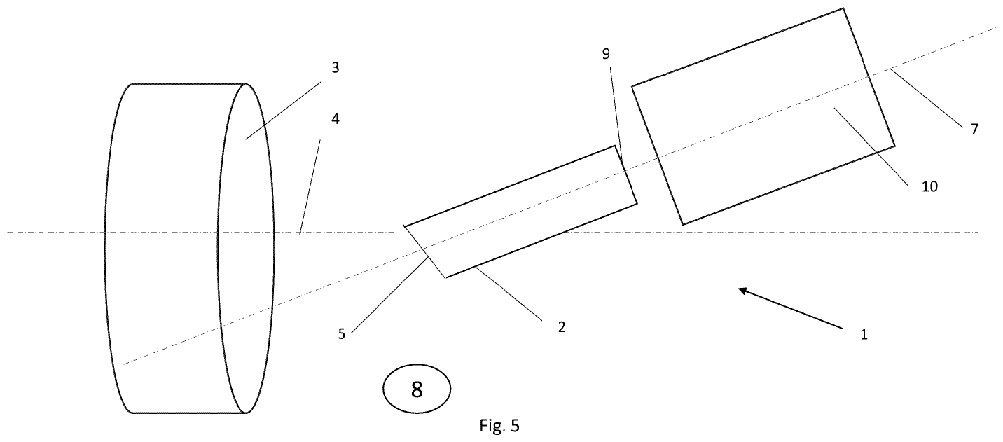

FIG. 5: a schematic representation of the device,

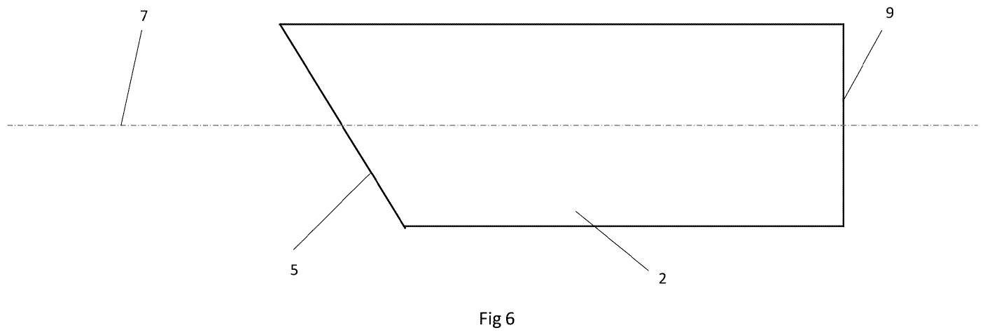

FIG. 6: a schematic representation of the optical fiber,

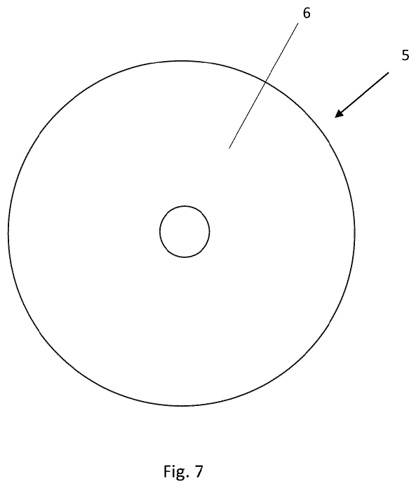

FIG. 7: a schematic representation of the decoupling surface.

FIG. 1 shows an illustration of the optical elements of the device 1. The device 1 comprises an optical fiber 2 and a main lens 3. The optical axes of the main lens 3 and the optical fiber 2 are not identical or coaxial. Both the main lens 3 and the optical fiber 2 are each held in mounts 11, 12, whereby the mount 11 of the optical fiber 2 also comprises the receiver 8. Laser light with a wavelength in a range of 490 nm to 950 nm comes out of the optical fiber 2, which is sent as transmitted radiation 13 through the main lens 3 onto an object to be measured. The object reflects the radiation back, whereby it is guided through the main lens 3 as received radiation 14 back to the receiver 8 (see FIG. 5). The main lens 3 is covered with small white colored dots as dispersion spatter on the side facing the optical fiber 2, so that a small part of the transmitted radiation 13 is immediately reflected back again. This reflected radiation is used as calibration radiation. The dispersion spatter makes the calibration radiation diffuse. The diffuse calibration radiation is also detected by the receiver 8 (see FIG. 5) and further processed in the electronics.

FIG. 2 shows the device from FIG. 1 with a holder 15, which connects the mount 11 of the receiver 8 and the optical fiber 2 and the mount 12 of the main lens 3. The coefficient of thermal expansion of the mounts 11, 12 is equal to and greater than the coefficient of thermal expansion of the holder 15 of the mounts 11, 12. In this case, the mounts 11 and 12 are made of an aluminum alloy and the holder 15 is made of carbon fiber.

FIG. 3 shows a schematic representation of the received radiation 14, which is directed from the main lens (not shown) onto the reflective layer 6 and from there onto the receiver 8. The receiver 8 is an avalanche photodiode.

FIG. 4 shows a schematic representation of the received radiation 14 on the main lens 3.

FIG. 5 shows a schematic representation of the device 1 with the optical fiber 2 and the main lens 3. The optical fiber 2 has an optical axis 7 which is not identical to the optical axis 4 of the main lens 3. The angle between the optical axes is essentially 20°, in particular a range of 16° to 20°. The optical fiber 2 also has a coupling surface 9 for laser light. The laser light is generated by the laser source 10, a laser diode. The optical fiber 2 has a decoupling surface 5, which has a non-perpendicular angle to the optical axis 7 of the optical fiber and a non-perpendicular angle to the optical axis 4 of the main lens 3. The combination of the two angles essentially results in a 45° angle of the decoupling surface to the optical axis 4 of the main lens 3. The angles between optical axis 7 of optical fiber 2 and optical axis 4 of the main lens are 16°, 29° grinding angle of the optical fiber, i.e. angle between optical axis 7 of the optical fiber and decoupling surface 5 and 45° between reflective layer 6 and optical axis of the main lens 3. Alternatively, an angle of 50° between the reflective layer 6 and the optical axis of the main lens 3 would be conceivable, with an angle of 18.3° between the optical axis of the optical fiber 2 and the optical axis of the main lens 3 and an angle of 31.7° between the grinding angle of the optical fiber 2. Another alternative would be an angle of 52° between the reflective layer 6 and the optical axis of the main lens 3, with an angle of 19.2° between the optical axis 7 of the optical fiber 2 and the optical axis 4 of the main lens 3 and an angle of 32.8° for the optical fiber 2. At these angles, no components of the receiver 8 are in the light cone of the receiving or transmitting radiation 14, 13. The decoupling surface 5 is also annularly coated with a reflective layer 6. This means that the radiation generated by the laser diode 10 can be directed through the optical fiber 2 and in the middle through the decoupling surface 5 onto the main lens 3. This transmitted radiation 13 (see FIG. 1), which is transmitted through the main lens 3, is then reflected by an object and returns as received radiation 14 (see FIG. 1) through the main lens 3 onto the output surface 5. The reflective layer 6 (see FIG. 7) of the output surface 5 reflects the light reflected by an object onto the receiver 8. In addition, the main lens 3 has small white diffusely reflecting colored dots as dispersion spatters on its side facing the optical fiber 2, which immediately reflect the transmitted radiation 13 from the optical fiber 2 and thus send back a diffuse reflection light as a calibration signal. The dispersion spatters reflect 5% to 15% of the emitted laser power. A signal processing device and signal processing electronics are connected to the receiver 8. The signals can be processed by these elements and thus the distance of the object can be determined.

FIG. 6 shows the optical fiber 2 with the decoupling surface 5. The decoupling surface 5 is arranged at a non-perpendicular angle to the optical axis 7 of the optical fiber 2. This means that the reflective layer 6 on the decoupling surface 5 can reflect the received light and guide it to the receiver 8 without the light having to return to the optical fiber 2. The optical fiber 2 also has an input coupling surface 9, which can include an input coupling device.

FIG. 7 shows a cross-section of the optical fiber 2 with the decoupling surface 5. The ring-shaped reflective layer 6 is arranged on the decoupling surface 5. The transmitted radiation 13 can emerge from the optical fiber 2 in the central circular area and the received radiation 14 is reflected back onto the reflective layer 6 on the receiver 8.

Transmitting and receiving radiation are not shown in FIGS. 6 and 7.

1-14. (canceled)

15. A device for measuring a distance of an object on which la-ser radiation modulated and emitted by the device are reflected, comprising an optical fiber into which laser radiation can be coupled and a main lens, through which the laser radiation can be emitted along an optical axis of the main lens, wherein the optical fiber comprises a de-coupling surface, wherein a reflection layer is arranged on the decoupling surface.

16. The device according to claim 15, wherein the decoupling surface has a non-perpendicular angle to the optical axis of the optical fiber.

17. The device according to claim 15, wherein laser radiation can be conducted from the reflection layer to a receiver.

18. The device according to claim 15, wherein the optical fiber is a single mode optical fiber.

19. The device according to claim 15, wherein the optical fiber comprises a coupling device on a coupling surface.

20. The device according to claim 15, wherein the device comprises a laser source, the light of which can be coupled into the optical fiber and can be generated by the preferred light with a wavelength in a range of essentially 490 to 950 nm.

21. The device according to claim 15, wherein the main lens is at least partially covered with dispersion spatters on the side facing the optical fiber, so that diffuse light can be reflected.

22. The device according to claim 15, wherein the main lens is a spherical lens.

23. The device according to claim 15, wherein the main lens is an aspherical lens.

24. The device according to claim 15, wherein an optical axis of the main lens is arranged neither coaxially nor parallel relative to the optical axis of the optical fiber, but has an angle in the range of 1-359°.

25. The device according to claim 15, wherein both the receiver and the main lens are held in a mount which has a greater coefficient of thermal expansion than the holder connecting the mounts.

26. A process for producing an optical fiber for use in a de-vice according to claim 15, wherein
the decoupling surface is coated with a reflecting layer,
removing the reflective layer from the decoupling surface in a transmission range around the center of the optical fiber by introducing UV light into the optical fiber, so that only the central range of the reflective layer is removed again.

27. The process for measuring a distance of an object at which la-ser radiation modulated and emitted by a device according to claim 15 are reflected, wherein
a laser source generates modulated laser light as transmitted radiation,
the transmitted radiation is coupled into the optical fiber,
the transmitted radiation is coupled out of the optical fiber through the transmission area in the decoupling surface,
the transmitted radiation passes through the main lens,
the transmitted radiation is reflected by an object,
the reflected laser light passes through the main lens as received radiation,
the received radiation is at least partially reflected at the reflecting layer of the decoupling surface and directed to a receiver.

28. A device for measuring a distance of an object at which laser radiation modulated and emitted by the device are reflected, comprising an optical fiber into which laser radiation can be coupled and a main lens through which the laser radiation can be emitted along an optical axis, wherein the laser radiation can be coupled back into the optical fiber through the main lens after reflection at the object and the reflected light can be detected by a receiver after passing through the optical fiber.
